(19) United States
(12) Patent Application Publication
(10) Pub. No.: US 2015/0246828 A1
(43) Pub. Date: Sep. 3, 2015

(54) MEMBRANE DISTILLATION MODULE

(71) Applicant: Korea Institute of Science and Technology, Seoul (KR)

(72) Inventors: Seongpil JEONG, Seoul (KR); Seockheon LEE, Seoul (KR)

(73) Assignee: Korea Institute of Science and Technology, Seoul (KR)

(21) Appl. No.: 14/624,913

(22) Filed: Feb. 18, 2015

(30) Foreign Application Priority Data
Mar. 3, 2014 (KR) 10-2014-0024983

(51) Int. Cl. C02F 1/44; B01D 71/32; B01D 71/34; B01D 69/02; B01D 71/64; B01D 71/56; B01D 71/06; B01D 61/36; B01D 71/68

(52) U.S. Cl. CPC C02F 1/447; B01D 61/364; B01D 71/32; B01D 71/34; B01D 71/68; B01D 71/64; B01D 71/56; B01D 71/06; B01D 69/02; B01D 2325/38; C02F 2101/10

(57) ABSTRACT

Disclosed is a membrane distillation module, including a feed water side, a separation membrane, and a treated water side, wherein a heat carrier is disposed in the feed water side. Also, the membrane distillation module can further include a heat diffuser, which is disposed to be in contact with the heat carrier in order to enhance heat diffusion efficiency toward the separation membrane, as required.

### BACKGROUND OF THE INVENTION

1. Field of the Invention

The present invention relates to a membrane distillation module, which is employed in a water treatment process, especially a membrane distillation process.

2. Description of the Related Art

A membrane distillation process is performed in such a manner that phase changes occur on the surface of a hydrophobic polymer separation membrane and the resulting vapor passes through the surface micropores of the separation membrane and is condensed and separated. This process is applied to a desalting process for separating and removing a non-volatile material or a material having relatively low volatility, or to separation of an organic material having high volatility from an aqueous solution.

Thorough research into membrane distillation began in 1940 at which the concept of membrane distillation was first proposed, and has been mainly carried out in U.S.A., Europe, Japan, and Australia. Furthermore, recent attempts are being made to replace a conventional separation process, which uses evaporation or a reverse osmotic membrane, with a membrane distillation process.

An evaporation process and a reverse osmosis process, both currently useful for production of pure water or for desalination, require a large quantity of energy. In particular, a reverse osmosis process is problematic because it incurs pollution and fouling and thus requires a plurality of pretreatment steps before use, making it difficult to control the operation of the process. Moreover, since this process operates at high pressure, a large quantity of electric energy is used as a pump power source, undesirably causing high management cost.

On the other hand, a membrane distillation process using a porous membrane may operate at low pressure compared to ultrafiltration and reverse osmosis, and enables the separation due to a partial vapor pressure difference. Also, such a membrane distillation process may play a role in separating and removing a non-volatile material such as a salt, without entrainment and without the need for a filter or a separation membrane operating at high pressure, compared to typical distillation processes.

When the membrane distillation process having the advantages described above is employed in a desalination (desalting) process, low utility cost and high durability of separation systems may result. Accordingly, this membrane distillation process is receiving attention as a competitive process in drinking water production around the world.

Also, in a membrane distillation process using a hydrophobic polymer separation membrane, a solvent or solute (a hydrophilic material) in a liquid phase does not pass through the membrane pores because the surface tension thereof is greater than that of the separation membrane, and is repelled from the surface of the separation membrane. Then, as the separating material is converted into a vapor phase at the entrances of the surface pores of the separation membrane, the resulting vapor is diffused into the pores, permeates the membrane, and is finally condensed and separated at the permeated side.

The membrane distillation process is implemented by a membrane distillation module comprising a feed water side where a feed solution passes through a separation membrane and a treated water side where a separating material is condensed and separated.

However, in the membrane distillation process, since thermal energy is essentially used to create a vapor pressure difference between the feed water side and the treated water side, the cost required to ensure thermal energy represents a very large proportion of the total operating cost. Hence, this process is disadvantageous in terms of cost, compared to other water treatment processes.

Furthermore, a temperature difference between feed water and treated water is made constant so as to continuously maintain a vapor pressure difference, which is regarded as important in the membrane distillation process. Thus, the effective transfer of heat to the inside of the membrane distillation module has a significant influence on water treatment performance by the membrane distillation process.

Accordingly, there is required to develop technology for minimizing thermal energy loss in the membrane distillation process so as to reduce energy cost, and for effectively transferring thermal energy into the membrane distillation module so as to enhance water treatment performance.

### SUMMARY OF THE INVENTION

Therefore, the present invention has been made keeping in mind the above problems encountered in the related art, and an object of the present invention is to provide a membrane distillation module, which is prevented from heat loss in the course of transporting feed water heated outside the module into a feed water side of the module, and also which enables heat to be efficiently and uniformly supplied to the feed water of the feed water side of the module to thereby reduce the thermal energy cost and increase the yield of treated water.

The present invention pertains to a membrane distillation module and, more particularly, to a membrane distillation module, which includes a feed water side, a separation membrane, and a treated water side, wherein a heat carrier is disposed in the feed water side.

Also, a heat diffuser may be further disposed to be in contact with the heat carrier so as to enhance heat diffusion efficiency toward the separation membrane, as required.

According to the present invention, the membrane distillation module may be provided in any type without particular limitation, for example, a submerged or pressurized type.

In the present invention, raw water of the feed water side has a relatively high temperature compared to treated water of the treated water side, in order to create a vapor pressure difference between the feed water side and the treated water side. The temperature difference between the feed water side and the treated water side is not particularly limited, but is preferably set to 600° C. or less, taking into consideration energy efficiency and pure water yield.

Also, in the membrane distillation module according to the present invention, the flow of the feed water (raw water) of the feed water side may be stopped repetitively for a predetermined period of time in order to increase a water purification quantity. After a sufficient water purification quantity is obtained by stopping the flow of the feed water side, the residual raw water in the membrane distillation module is discharged to the outside, new raw water is fed to the feed water side of the membrane distillation module, and the flow of the feed water side is stopped again. As such, the aforementioned procedures may be repeated.

According to the present invention, the membrane distillation module does not continuously maintain the flow of the feed water side, but may control the flow of the feed water at a predetermined time interval. Hence, compared to a conventional membrane distillation module, pump energy required for the flow of the feed water side may be reduced.

In the present invention, the heat carrier is not particularly limited, and any heat carrier may be used so long as it has high thermal conductivity. Also, any heat carrier may be used so long as it is manufactured using a typical process. For example, useful is a heat carrier manufactured by filling a polymer resin with a thermally conductive filler, such as a metal filler, a carbon filler, or a nitrogen filler, or is a heat carrier made of a metal material having high thermal conductivity, such as copper, or aluminum.

Also, the feed water receiving space of the feed water side is made smaller than the treated water receiving space of the treated water side, as required, and thereby the feed water fed into the module may be more rapidly heated. In the present invention, the ratio of the volume of the feed water receiving space of the feed water side to the volume of the treated water receiving space of the treated water side is not particularly limited, but is preferably set to 1:1.01˜100.

In the present invention, the material for the heat diffuser may include a metal material, such as iron, copper, or aluminum; or a material having high thermal conductivity, such as carbon nanotubes, graphene, or fullerene, and may be the same as that of the heat carrier.

The position of the heat diffuser in the module is not particularly limited, but the heat diffuser is preferably disposed to be in close contact with the heat carrier in order to maximize the rate of transfer of heat supplied from the heat carrier.

In the membrane distillation module, the separation membrane is preferably a hydrophobic polymer separation membrane. As the hydrophobic polymer separation membrane, any water treatment membrane may be used so long as it is composed of a hydrophobic polymer. The hydrophobic polymer may include at least one selected from among polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA).

According to the present invention, a membrane distillation module is configured such that a heat carrier is disposed in a feed water side thereof, and thus heat can be directly supplied to feed water of the feed water side, thereby preventing heat loss in the course of conventionally transporting feed water heated outside the module into the module. The module can further include, in addition to the heat carrier, a heat diffuser made of a material having high thermal conductivity with a large specific surface area for heat transfer, thus efficiently supplying heat to the feed water of the feed water side and uniformly supplying heat to the total feed water in the module. Ultimately, the thermal energy cost can be reduced, and the yield of treated water relative to consumed energy can be increased.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a membrane distillation system including a membrane distillation module according to an embodiment of the present invention;

FIG. 2 illustrates a membrane distillation system including no raw water supply pump, unlike the membrane distillation system of FIG. 1;

FIG. 3 illustrates a membrane distillation system including a membrane distillation module according to another embodiment of the present invention; and

FIG. 4 illustrates a membrane distillation system including no raw water supply pump, unlike the membrane distillation system of FIG. 3;

### DESCRIPTION OF SPECIFIC EMBODIMENTS

Hereinafter, a detailed description will be given of the present invention.

The present invention addresses a membrane distillation module. More specifically, the present invention addresses a membrane distillation module including a feed water side, a separation membrane, and a treated water side, wherein a heat carrier is disposed in the feed water side.

Also, a heat diffuser may be further disposed to be in contact with the heat carrier so as to enhance heat diffusion efficiency toward the separation membrane, as required.

According to the present invention, the membrane distillation module may be provided in any type without particular limitation, for example, a submerged or pressurized type. Furthermore, the membrane distillation module according to the present invention may be applied to any type of membrane distillation module, for example, a direct contact membrane distillation (DCMD) type, an air gap membrane distillation (AGMD) type, a vacuum membrane distillation (VMD) type, and a sweep gas membrane distillation (SGMD) type.

In the present invention, the feed water side of the membrane distillation module is a part where external raw water is passed. While passing the external raw water through the feed water side of the membrane distillation module, a vapor present in the raw water moves to the treated water side through the separation membrane due to a vapor pressure difference between the feed water side and the treated water side.

In the present invention, any raw water may be used so long as pure water needs to be separated therefrom, and examples thereof may include sewage or seawater. The raw water of the feed water side of the module has a relatively high temperature compared to the treated water of the treated water side, in order to cause a vapor pressure difference between the feed water side and the treated water side. The temperature difference between the feed water side and the treated water side is not particularly limited, but is preferably set to 600° C. or less, taking into consideration energy efficiency and pure water yield.

Furthermore, to increase the vapor permeability through the separation membrane, the temperature of the feed water side is favorably set as high as possible. As the temperature of the feed water of the feed water side is higher, vapor pressure may increase, consequently enhancing a vapor pressure difference between the feed water side and the treated water side, which is a driving force of vapor permeation through the separation membrane.

Also, in the membrane distillation module according to the present invention, the flow of the feed water (raw water) of the feed water side may be stopped repetitively for a predetermined period of time in order to increase a water purification quantity. After a sufficient water purification quantity is obtained by stopping the flow of the feed water side, the residual raw water in the membrane distillation module is discharged to the outside, new raw water is fed to the feed water side of the membrane distillation module, and the flow of the feed water side is stopped again. As such, the aforementioned procedures may be repeated.

Also, while raw water is continuously fed, a concentrated raw water residue (concentrated water) may be discharged at a predetermined flow rate. When a predetermined period of time has elapsed after operation or when the concentration of concentrated water is increased to a predetermined level or more, it is possible to carry out the membrane distillation process using the membrane distillation module in such a manner that the concentrated water is discharged.

According to the present invention, the membrane distillation module does not continuously maintain the flow of the feed water side, but may control the flow of feed water at a predetermined time interval. Hence, compared to a conventional membrane distillation module, pump energy required for the flow of the feed water side may be reduced.

In the membrane distillation module according to the present invention, the heat carrier is disposed to a portion of the feed water side of the module so that heat supplied from an external heat source is effectively transferred toward the feed water of the feed water side near the separation membrane. In conventional membrane distillation technology, heat loss occurs in the course of feeding raw water preheated outside into the membrane distillation module, and thus energy efficiency may deteriorate. However, in the present invention, raw water is not preheated outside, but is directly subjected to heat by the heat carrier heated by the external heat source in the feed water side of the membrane distillation module, thus minimizing heat loss. Moreover, the space of the feed water side is made small so that heat is locally supplied toward the membrane, thereby reducing energy consumption compared to thermal energy conventionally consumed for the feed water in the total space of the feed water side.

The heat carrier is not particularly limited, and any heat carrier may be used so long as it has high thermal conductivity. Also, any heat carrier may be used so long as it is manufactured using a typical process. For example, a heat carrier manufactured by filling a polymer resin with a thermally conductive filler, such as a metal filler, a carbon filler, or a nitrogen filler, may be used. Alternatively, a heat carrier made of a metal material having high thermal conductivity, such as copper, or aluminum, may be utilized.

The heat carrier may be provided in any form, including a planar pad, sheet, or mesh form. In particular, so long as it is possible to efficiently and uniformly transfer heat to the feed water side near the separation membrane, particular limitations are not imposed on the form and the position of the heat carrier.

The external heat source is a heat supply source positioned outside the membrane distillation module according to the present invention, and the kind thereof is not particularly limited. Any heat source may be used so long as it supplies heat to the heat carrier. Examples thereof may include an electric heater, a gas heater, and a solar heater.

Also, the feed water receiving space of the feed water side is made smaller than the treated water receiving space of the treated water side, as required, and thereby the feed water fed into the module may be more rapidly heated. In the present invention, the ratio of the volume of the feed water receiving space of the feed water side to the volume of the treated water receiving space of the treated water side is not particularly limited, but is preferably set to 1:1.01˜100. If the ratio of the volume of the feed water receiving space to the volume of the treated water receiving space is less than 1:1.01, an effect of shortening the heating time of raw water of the feed water side may become insignificant, compared to when the volume ratio is 1:1. In contrast, if the ratio of the volume of the feed water receiving space to the volume of the treated water receiving space exceeds 1:100, the volume of the feed water receiving space is too small, making it difficult to achieve the water purification quantity as desired in the present invention.

Also, the membrane distillation module according to the present invention may further include a heat diffuser for uniformly diffusing heat supplied by the heat carrier to the feed water in the module. The heat diffuser is preferably made of a material having high thermal conductivity with a large surface area so as to uniformly and effectively transfer heat to the total feed water in the module from the heat carrier. The material for the heat diffuser may include a metal material, such as iron, copper, or aluminum; or a material having high thermal conductivity, such as carbon nanotubes, graphene, or fullerene, and may be the same as that of the heat carrier. Also, the heat diffuser may be provided in any form so long as it enables heat to be uniformly and effectively diffused to the total feed water flowing in the module. For example, as the heat diffuser may be provided in the form of cotton screen, mesh or honeycomb, it has a large specific surface area but may act as a resistance to some extent to the flow of the feed water so that the retention time of the feed water in the module may become longer and thus heat is uniformly supplied to the total feed water in the module. Thereby, heat may be more intensively and efficiently supplied to the feed water in the module relative to the supplied thermal energy, thus increasing the temperature thereof.

The position of the heat diffuser in the module is not particularly limited, but the heat diffuser is preferably disposed to be in close contact with the heat carrier in order to maximize the rate of transfer of heat supplied from the heat carrier.

In the membrane distillation module according to the present invention, the separation membrane is preferably a hydrophobic polymer separation membrane. The reason why the hydrophobic polymer separation membrane is used is as follows: a solvent or solute (a hydrophilic material) in a liquid phase, having a surface tension greater than that of the separation membrane, does not pass through membrane pores but is repelled from the surface of the separation membrane, and thus, the separating material is converted into a vapor phase at the entrances of the surface pores of the separation membrane and the resulting vapor is diffused into the pores, permeates the membrane, and is finally condensed and separated at the treated water side.

As the hydrophobic polymer separation membrane, any water treatment membrane may be used so long as it comprises a hydrophobic polymer. The hydrophobic polymer may include at least one selected from among polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA).

In the membrane distillation module, the treated water side is a part where the vapor passed through the separation membrane is condensed and separated, and the treated water, which is pure water separated from the raw water through the separation membrane, is collected and flows. In the present invention, the temperature of the treated water of the treated water side of the module is relatively lower than that of the feed water.

A better understanding of the present invention may be obtained via the following embodiments that are set forth to illustrate, but are not to be construed as limiting the present invention.

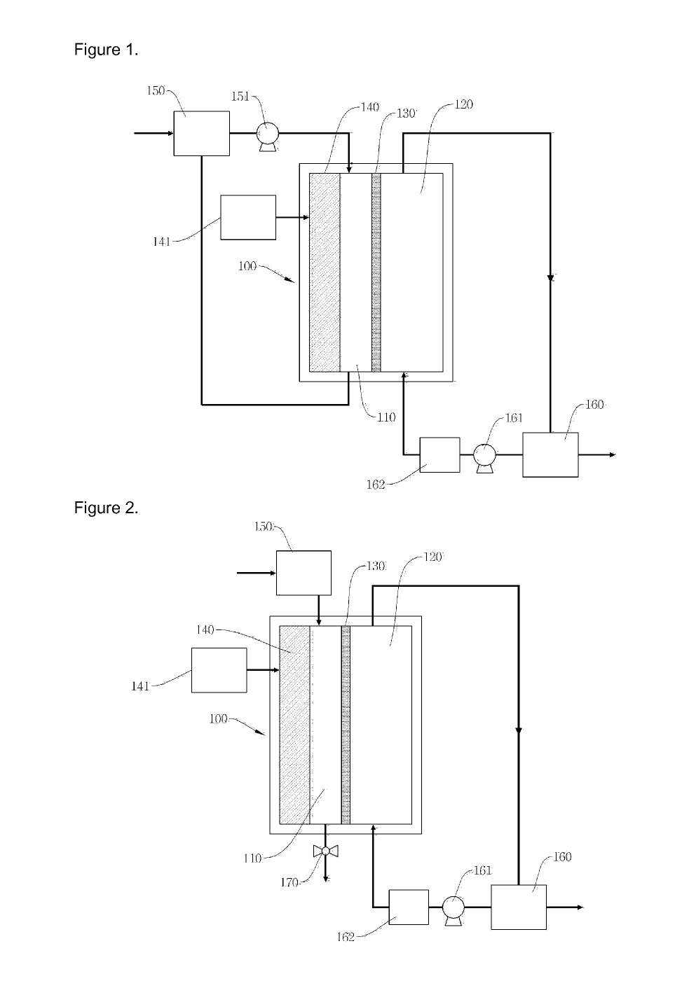

FIG. 1 illustrates a membrane distillation system including a membrane distillation module according to an embodiment of the present invention. As illustrated in FIG. 1, a membrane distillation module 100 includes a feed water side 110, a treated water side 120, and a separation membrane 130.

A heat carrier 140 is disposed to a portion of the feed water side 110, and functions to transfer thermal energy to the feed water of the feed water side 110 from an external heat source 141.

The feed water side 110 is an area where external raw water stays in the membrane distillation module 100. While the external raw water stays in the feed water side 110, a vapor present in the raw water moves to the treated water side 120 through the separation membrane 130 due to a vapor pressure difference between the feed water side 110 and the treated water side 120.

The raw water, which is fed into the feed water side 110 and stays near the separation membrane 130, is heated by thermal energy transferred from the heat carrier 140. Thereby, pure water contained in the raw water of the feed water side 110 is vaporized, and the vapor pressure of the feed water side 110 is enhanced.

Referring to FIG. 1, the operation of the system according to the present invention is described below.

Specifically, raw water stored in a raw water storage tank 150 is fed into the feed water side 110 of the membrane distillation module 100 by means of a raw water circulation pump 151. As illustrated in FIG. 1, when the feed water side 110 is filled with the fed raw water, the raw water circulation pump 151 functions to prevent the raw water from flowing thereto, or may control continuous water circulation. Subsequently, the raw water in the feed water side 110 is heated by thermal energy transferred from the heat carrier 140 disposed to a portion of the feed water side 110, and thereby pure water contained in the raw water is vaporized, thus enhancing the vapor pressure of the feed water side 110. On the other hand, the treated water side 120 of the membrane distillation module 100 is an area where treated water is continuously circulated and flows. The treated water is allowed to flow into the membrane distillation module 100 from a treated water storage tank 160 by a treated water circulation pump 161. In this procedure, the treated water is cooled by a cooler 162, and then fed into the treated water side 120 of the membrane distillation module 100. The treated water is continuously circulated, and some of the treated water stored in the treated water storage tank 160 is pure water and is discharged to the outside. A temperature difference between the feed water side 110 and the treated water side 120 creates a vapor pressure difference. Also, due to the vapor pressure difference between the feed water side 110 and the treated water side 120, a vapor of pure water contained in the raw water of the feed water side 110 moves to the treated water side 120 through the separation membrane 130. Furthermore, the vapor moved to the treated water side 120 is condensed due to low temperature of the treated water side 120 and becomes pure water. As such, since the separation membrane 130 is hydrophobic, liquid residues other than the vaporized pure water of the feed water side 110 do not pass through the separation membrane 130.

Meanwhile, when the raw water staying in the feed water side 110 is sufficiently purified, the residual raw water of the feed water side 110 is discharged outside the membrane distillation module 100, and new raw water is fed to the feed water side 110 from the raw water storage tank 150 in response to operation of the raw water circulation pump 151. These procedures are repeated. When continuous operation is carried out, new raw water is fed into the raw water storage tank 150, so that the inner concentration of the raw water storage tank 150 may be adjusted. Thus, when the inner concentration of the raw water storage tank 150 is sufficiently increased, the raw water concentrate is removed from the raw water storage tank 150, and new raw water may be fed thereto.

FIG. 2 illustrates a membrane distillation system having no raw water supply pump, unlike the membrane distillation system of FIG. 1. As purification is carried out, when the concentration of the feed water side 110 is high, a valve 170 is opened so that the residual raw water in the feed water side 110 is discharged outside the module, and new raw water may be continuously fed into the feed water side 110 from a raw water storage tank 150 by gravity. As such, energy required to operate the raw water supply pump may be saved.

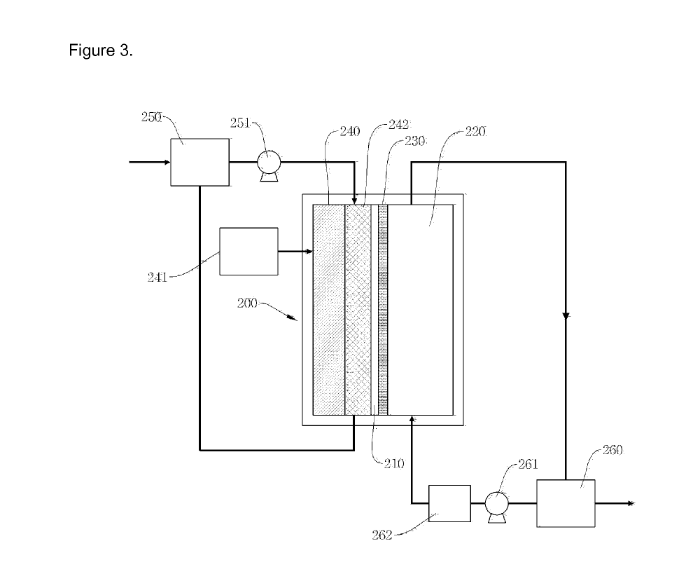

FIG. 3 illustrates a membrane distillation module according to another embodiment of the present invention. As illustrated in FIG. 3, a membrane distillation module 200 according to the present invention includes a feed water side 210, a treated water side 220, and a separation membrane 230.

A heat carrier 240 is disposed to a portion of the feed water side 210, and is responsible for transferring thermal energy to the feed water of the feed water side 210 of the membrane distillation module 200 from an external heat source 241.

Also, a heat diffuser 242 having a mesh structure with high thermal conductivity is disposed to be in close contact with the heat carrier 240.

The raw water, which is fed into the feed water side 210 and stays near the separation membrane 230, is uniformly and efficiently heated by thermal energy supplied from the heat carrier 240 via the heat diffuser 242 having high thermal conductivity and a large specific surface area. Thereby, pure water contained in the raw water of the feed water side 210 is more uniformly vaporized, and the vapor pressure of the feed water side 210 is enhanced.

With reference to FIG. 3, the operation according to the present invention is described below.

Specifically, raw water stored in a raw water storage tank 250 is fed into the feed water side 210 of the membrane distillation module 200 by means of a raw water circulation pump 251. When the feed water side 210 is filled with the fed raw water, the feed of the raw water may be prevented, or the raw water may be continuously circulated. Subsequently, the raw water in the feed water side 210 is heated by thermal energy transferred via the heat diffuser 242 from the heat carrier 240 that is disposed to a portion of the feed water side 210, and thereby pure water contained in the raw water is vaporized, thus enhancing the vapor pressure of the feed water side 210. On the other hand, the treated water side 220 of the membrane distillation module 200 is an area where treated water is continuously circulated and flows. The treated water is allowed to flow into the membrane distillation module 200 from a treated water storage tank 260 by a treated water circulation pump 261. In this procedure, the treated water is cooled by a cooler 262, and then fed into the treated water side 220 of the membrane distillation module 200. The treated water is continuously circulated, and some of the treated water stored in the treated water storage tank 260 is pure water and is discharged to the outside. A temperature difference between the feed water side 210 and the treated water side 220 creates a vapor pressure difference. Also, due to the vapor pressure difference between the feed water side 210 and the treated water side 220, a vapor of pure water contained in the raw water of the feed water side 210 moves to the treated water side 220 through the separation membrane 230. Furthermore, the vapor moved to the treated water side 220 is condensed due to low temperature of the treated water side 220 and becomes pure water. As such, since the separation membrane 230 is hydrophobic, liquid residues other than the vaporized pure water of the feed water side 210 do not pass through the separation membrane 230.

Meanwhile, when the raw water staying in the feed water side 210 is sufficiently purified, the residual raw water of the feed water side 210 is discharged outside the membrane distillation module 200, and new raw water is fed to the feed water side 210 from the raw water storage tank 250 in response to operation of the raw water circulation pump 251. These procedures are repeated.

When continuous operation is carried out, new raw water is fed into the raw water storage tank 250, so that the inner concentration of the raw water storage tank 250 may be adjusted. Thus, when the inner concentration of the raw water storage tank 250 is sufficiently increased, the raw water concentrate is removed from the raw water storage tank 250, and new raw water may be fed thereto.

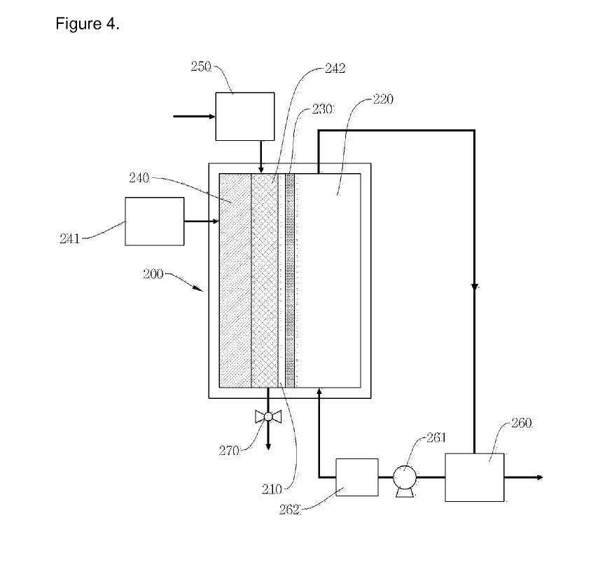

FIG. 4 illustrates a membrane distillation system having no raw water supply pump, unlike the membrane distillation system of FIG. 3. As purification is carried out, when the concentration of the feed water side 210 is high, a valve 270 is opened so that the residual raw water in the feed water side 210 is discharged outside the module, and new raw water may be continuously fed into the feed water side 210 from a raw water storage tank 250 by gravity. As such, energy required to operate the raw water supply pump may be saved.

As described hereinbefore, those skilled in the art will appreciate that the present invention may be embodied in other specific ways without changing the technical spirit or essential features thereof. The scope of the present invention is represented by the following claims, rather than the detailed description, and it is to be construed that the meaning and scope of the claims and all variations or modified forms derived from the equivalent concept thereof are encompassed within the scope of the present invention.

What is claimed is:

1. A membrane distillation module, comprising a feed water side, a separation membrane, and a treated water side, wherein a heat carrier is disposed in the feed water side.

2. The membrane distillation module of claim 1, wherein the heat carrier comprises a material obtained by filling a polymer resin with a thermally conductive filler.

3. The membrane distillation module of claim 2, wherein the thermally conductive filler comprises any one selected from the group consisting of a metal filler, a carbon filler, and a nitrogen filler.

4. The membrane distillation module of claim 1, wherein the heat carrier comprises a metal material.

5. The membrane distillation module of claim 4, wherein the metal material is copper or aluminum.

6. The membrane distillation module of claim 1, wherein a heat diffuser is disposed to be in contact with the heat carrier.

7. The membrane distillation module of claim 6, wherein the heat diffuser comprises a metal material.

8. The membrane distillation module of claim 6, wherein the heat diffuser comprises any one selected from the group consisting of carbon nanotubes, graphene, and fullerene.

9. The membrane distillation module of claim 1, wherein the membrane distillation module is provided in a submerged or pressurized type.

10. The membrane distillation module of claim 1, wherein a temperature difference between the feed water side and the treated water side is 600° C. or less.

11. The membrane distillation module of claim 1, wherein the separation membrane is a hydrophobic polymer separation membrane.

12. The membrane distillation module of claim 11, wherein the hydrophobic polymer separation membrane comprises at least one selected from the group consisting of polytetrafluoroethylene (PTFE), polyvinylidene fluoride (PVDF), polysulfone (PSF), polyether sulfone (PES), polyether imide (PEI), polyimide (PI), polyethylene (PE), polypropylene (PP), and polyamide (PA).

13. The membrane distillation module of claim 1, wherein a ratio of volume of a feed water receiving space of the feed water side to volume of a treated water receiving space of the treated water side is 1:1.01˜100.

14. The membrane distillation module of claim 1, wherein flow of feed water of the feed water side is repetitively stopped for a predetermined period of time.
